(19) United States
(12) Patent Application Publication
(10) Pub. No.: US 2014/0172558 A1
(43) Pub. Date: Jun. 19, 2014

(54) PURCHASE TRANSACTION CONTENT DISPLAY

(71) Applicant: Christopher Kenneth Harris, Santa Clara, CA (US)

(72) Inventor: Christopher Kenneth Harris, Santa Clara, CA (US)

(21) Appl. No.: 13/713,796

(22) Filed: Dec. 13, 2012

(51) Int. Cl. G06Q 30/02

(52) U.S. Cl. CPC G06Q 30/0253
USPC 705/14.51

(57) ABSTRACT

Systems and methods of providing information via a computer network are provided. An indication of a transaction with a first merchant can be received via a computer network by a data processing system. The data processing system can create an index representing an inventory of a second merchant which is independent of the first merchant, and can identify a product from the inventory of the second merchant using the index and data associated with the indication of the transaction. The data processing system can provide content corresponding to the product for display at a computing device prior to completion of the transaction.

### BACKGROUND

In a networked environment such as the internet or other networks, entities such as people or companies using computing devices can provide information for public display, such as on web pages, documents, applications, or other information resources. The network content can include text, video, image, or audio information provided by the entities via a server for display on an information resource at a computing device. Additional content such as advertisements can also be provided by third parties for display on the information resources together with the information provided by the entities. The additional content may or may not be related to the subject matter of the information resources.

### SUMMARY

At least one aspect is directed to a computer-implemented method of providing information via a computer network. The method includes receiving, by a data processing system via a computer network, an indication of a transaction with a first merchant, and creating, by the data processing system, an index representing an inventory of a second merchant that is independent of the first merchant. The method includes identifying a product from the inventory of the second merchant using the index and data associated with the indication of the transaction, and providing content corresponding to the product for display at a computing device prior to completion of the transaction.

At least one aspect is directed to a system of providing information via a computer network. The system includes one or more data processors, and one or more storage devices that when executed by the one or more data processors, cause the one or more data processors to perform operations including receiving an indication of a transaction with a first merchant. The operations include creating an index representing an inventory of a second merchant that is independent of the first merchant. The operations further include identifying a product from the inventory of the second merchant using the index and data associated with the indication of the transaction. The operations also include providing content corresponding to the product for display at a computing device prior to completion of the transaction.

At least one aspect is directed to a computer readable storage device storing instructions that when executed by one or more data processors, cause the one or more data processors to perform operations including receiving an indication of a transaction with a first merchant. The operations include creating an index representing an inventory of a second merchant that is independent of the first merchant. The operations further include identifying a product from the inventory of the second merchant using the index and data associated with the indication of the transaction. The operations also include providing content corresponding to the product for display at a computing device prior to completion of the transaction.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram of an example system of providing information via a computer network, according to an illustrative implementation;

FIG. 2 is a flow diagram depicting an example method of providing information via a computer network, according to an illustrative implementation; and

FIG. 3 is a block diagram illustrating a general architecture for a computer system that may be employed to implement various elements of the systems and methods described and illustrated herein, according to an illustrative implementation.

### DETAILED DESCRIPTION

Following below are more detailed descriptions of various concepts related to, and implementations of, methods, apparatuses, and systems for providing information on a computer network. The various concepts introduced above and discussed in greater detail below may be implemented in any of numerous ways, as the described concepts are not limited to any particular manner of implementation. Examples of specific implementations and applications are provided primarily for illustrative purposes.

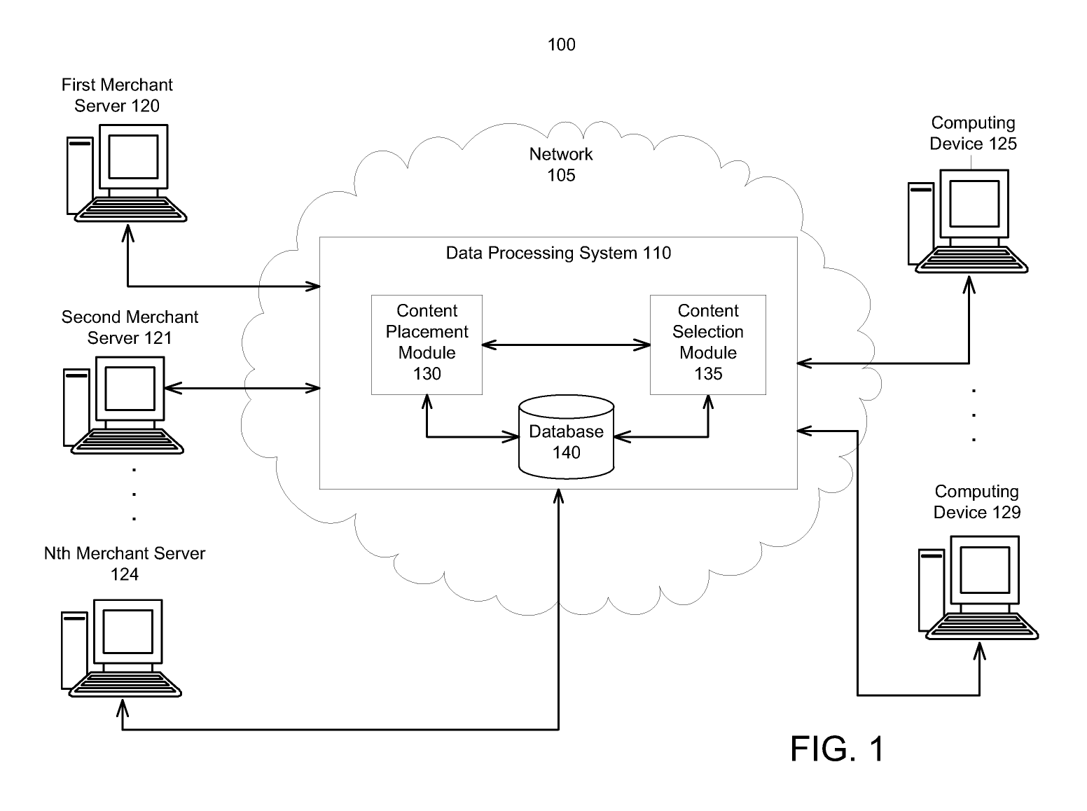

Referring now to FIG. 1 and in brief overview, in some implementations a customer can use a computing device 125 to interact with a first merchant server 120 via a computer network 105 to effect a transaction to purchase goods or services from a corresponding first merchant. The first merchant server 120 can notify a data processing system 110 of this transaction. The notification may include a request for a content item (e.g., an advertisement) for display by the computing device 125 prior to completion of the transaction. The notification can include information about the transaction, such as a type of product or service being purchased, an identification of the first server 120 or corresponding first merchant, or a computing device identifier associated with the computing device 125 used to purchase the goods or services from the first merchant.

The data processing system 110 can receive data from at least one of the merchant servers 120 to 124 and based on this data the data processing system 110 can create at least one index representing product inventories of one or more merchants. A database 140 associated with the data processing system 110 can store the indices. Subsequent to receiving a request for a content item, the data processing system 110 can communicate with the database 140 and evaluate the index. Based on information included in the request for the content item, the data processing system 110 can evaluate the index to identify products in the inventory of a second merchant that is a different merchant than the first merchant. Content items such as ads related to the identified products can be provided for display at the computing device 125 prior to completion of the transaction.

For example, when a customer is using the computing device 125 for a transaction to purchase a toaster on a website hosted by the first merchant server 120, during the checkout process, (e.g., prior to completion of the transaction) the first merchant server 120 (or the computing device 125) can transmit a request to the data processing system 110 for content items for additional goods or services to be displayed by the computing device 125. The data processing system 110 can access inventories of multiple merchants via indices stored in the database 140, and can identify the additional good or service. For example, based on information included with the request for content items that indicates a toaster is being purchased from a first merchant, the data processing system 110 might identify a toaster cover from the inventory of a second merchant as a suitable product, and can provide information about the toaster cover (e.g., a content item or ad) for display by the computing device 125 prior to completion of the transaction to purchase the toaster.

In this example, during a checkout process (e.g., online) to purchase an initial item, a consumer using the computing device 125 can be presented with additional items available for purchase at the computing device 125. These additional items can be available from the merchant's own inventory or from inventories of other merchants as indicated in at least on index created by the data processing system 110. To determine which additional items to offer, the data processing system 110 can evaluate the transaction, the network activity of the computing device 125, indices created by the data processing system 110 and representing third party merchant inventory, or activities of other computing devices 125 to 129 used for purchases of the same initial item or similar items. From this evaluation, the data processing system 110 can identify a product (e.g., good or service) or content (e.g., ad) representing the product, and the content can be provided for display at the computing device 125.

Referring to FIG. 1 in more detail, FIG. 1 illustrates an example system 100 of providing information via at least one computer network, such as a network 105. The network 105 can include computer networks such as the internet, local, wide, metro or other area networks, intranets, satellite networks, and other computer networks such as voice or data mobile phone communication networks. The system 100 can include at least one data processing system 110. The data processing system 110 can include at least one logic device such as a computing device having a processor to communicate via the network 105, for example with a plurality of merchant servers (e.g., a first merchant server 120, a second merchant server 121 through an Nth merchant server 124), or with a plurality of computing devices 125 to 129. The data processing system 110 can communicate with any number of merchant servers and computing devices.

The data processing system 110 can include at least one server. For example, the data processing system 110 can include a plurality of servers located in at least one data center. The data processing system 110 can include at least one content placement module 130, at least one content selection module 135, and at least one database 140. The content placement module 130 and the content selection module 135 can each include at least one processing unit or other logic device such as programmable logic arrays configured to communicate with the database 140. The content placement module 130 and the content selection module 135 can be separate components, a single component, application specific integrated circuit, one or more servers, gaming consoles, or part of the data processing system 110.

The merchant servers, for example the first merchant server 120, can include a computer having a server configured to host at least one web page or other information resource or online document. For example, the merchant servers 120 to 124 can include at least one FTP server, file sharing server, or web server, or a combination of servers such as a data center, or a cloud computing platform. In one implementation, the merchant servers 120 to 124 can host at least one web page for the computing devices 125 to 129 to purchase goods and services online through the network 105.

The computing devices 125 to 129 can include a computer, laptop, desktop, smart phone, tablet, personal digital assistant, or server device configured to communicate with other computing devices via the network 105. The computing device 125 can execute a software application (e.g., a web browser or other application) to send and receive data to and from other computing devices over network 105.

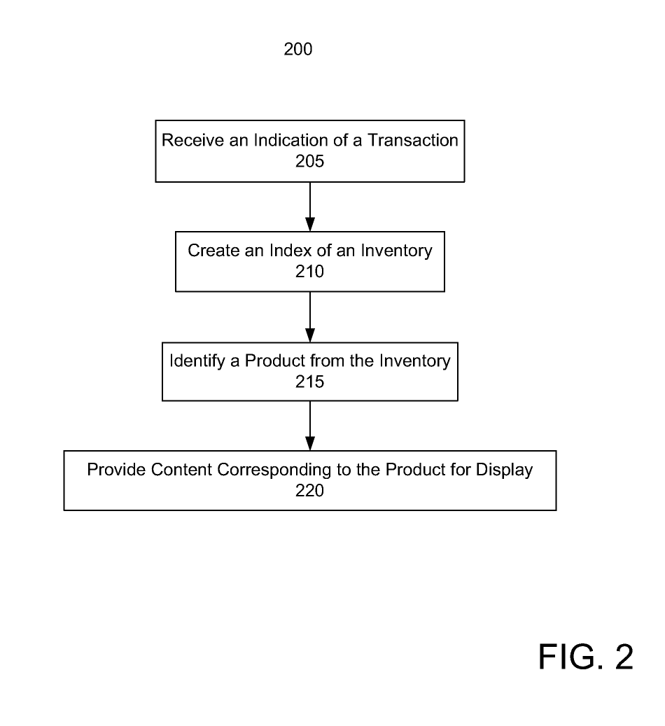

Referring to FIG. 1. and FIG. 2, in some implementations, the data processing system 110 receives, via the network 105, an indication of a transaction with a first merchant (BLOCK 205). The data processing system 110 can process data received from merchants (e.g., via the merchant servers 120 to 124) to create an index representing the inventory of at least one merchant (BLOCK 210). The data processing system 110 can create indices representing merchant inventory (BLOCK 210) before or after receiving an indication of the transaction (BLOCK 105). The indices can be updated periodically by the data processing system 110 based on data received via the network 105 from one of the merchant servers 120 to 124. Using the created index (BLOCK 210) and the received indication of the transaction (BLOCK 205), the data processing system 110 can identify a product from an inventory of a merchant (BLOCK 215). For example, subsequent to receiving an indication of a transaction between the first merchant server 120 and the computing device 125, the data processing system 110 can access the database 140 to identify a product from an inventory of a second merchant (BLOCK 215). The second merchant may be associated with the second merchant server 121. The data processing system 110 can identify a content item corresponding to the identified product, such as an image of the product or an ad for the product, and can provide the content item for display at the computing device (BLOCK 220). In some implementations, the data processing system 110 provides the content item for display at the computing device 125 prior to completion of the transaction.

In some implementations, the content placement module 130 receives an indication of a transaction with the first merchant server 120 (associated with a first merchant) via the network 105 (BLOCK 205). The transaction can indicate an attempt to purchase a product of the first merchant using the computing device 125. The first merchant server 120 can be associated with a first merchant, such as a business entity whose product is offered for sale at the first merchant server 120. In one implementation, the first merchant server 120 receives a purchase order from the computing device 125 and relays an indication of the order to the data processing system 110, where it is received (BLOCK 205).

The computing device 125 can access web pages hosted by the first merchant server 120 to purchase goods and services via the network 105. A consumer or user can manipulate an interface of the computing device 125 to select a good or service for purchase, such as by clicking a link or a checkout interface of a display to initiate a checkout process. For example, responsive to a selection of a good or service for purchase, the computing device 125 may communicate with the web pages hosted by the first merchant server 120 to purchase a toaster from a merchant associated with the first merchant server 120. During the checkout process, the data processing system 110 may receive an indication of the toaster purchase transaction from the first merchant server 120 (BLOCK 205).

In one implementation, the data processing system 110 creates at least one index representing an inventory of at least one merchant (BLOCK 210). For example, the data processing system 110 can receive data from a second merchant (via the second merchant server 121) to create an index representing the second merchant's inventory (e.g., products, goods, services, or items offered for sale by the second merchant) (BLOCK 210). The second merchant can be independent of the first merchant. For example the first merchant associated with the first merchant server 120 and the second merchant associated with the second merchant server 121 can be different and unrelated entities, neither of whom has access to the inventory, servers, or indices of the other.

The data processing system 110 can store the indices in at least one database 140. In some implementations, the first merchant server 120 and the second merchant server 121 do not have access to the database 140. For example, the first merchant server 120 and the second merchant server 121 are third party servers that communicate with the data processing system 110 via the network 105 and that cannot access the indices stored in the database 140 to determine their inventories. In this example, the first merchant server 120 and the second merchant server 121 may provide data to the data processing system 110 that the data processing system 110 uses to create indices (BLOCK 210), and the data processing system 110 (and not the merchant servers 120, 121) can access the indices via the database 140 to identify product inventory. The third party merchants may or may not have their own, separate, proprietary inventories or indices.

The data processing system 110 can create different indices representing inventories of different merchants and can store those indices in the database 140. For example, merchants using the services of the data processing system 110 to distribute content items for display on computing devices 125 may participate in a content item distribution service provided by the data processing system 110.

Merchants may be associated with more than one index. For example, the data processing system 110 can create multiple indices that indicate different categories of inventory of one merchant (BLOCK 210), such as the second merchant associated with the second merchant server 121. For example, the data processing system 110 can receive information from the second merchant server 121 that the second merchant offers for sale electronics and apparels and that this constitutes two inventory categories. From this information, the data processing system 110 can create on index (BLOCK 210) having two categories (e.g., an apparel category and an electronics category) or two indices, one for apparel and one for electronics for the same second merchant. The categories can include subcategories. For example, the electronics category may include a computer subcategory and a camera subcategory. In one implementation, the data processing system 110 may create indices (BLOCK 210) based on categories of products or goods. For example, an index representing an electronics inventory may include electronics products from different merchants with a mapping between particular products and particular merchants.

The data processing system 110 can create indices representing inventories of multiple merchants (BLOCK 210), such as the first merchant associated with the first merchant server 120 and with a transaction taking place at the computing device 125, as well as a second merchant having a corresponding second merchant server 121 that is not initially part of the transaction between the first merchant server 120 and the computing device 125.

In one implementation, the data processing system 110 can identify, using the index and data associated with the indication of the transaction, a product from the inventory of at least one merchant (BLOCK 215). The data associated with the indication of the transaction can include, for example, the product, good, or service purchased in the transaction conducted at the computing device 125. For example, a purchase transaction of a toaster may be conducted at the computing device 125 via the first merchant server 120. From this or other data indicating computing device 125 activity, the data processing system 110 may determine that the computing device 125 is associated with activity indicating an interest in a toaster cover or another peripheral product. In one implementation, the data processing system 110 may identify the product (e.g., the toaster cover) from the second merchant using the index representing the inventory of the second merchant (BLOCK 215). For example, the data processing system 110 may determine that the transaction or activity of the computing device 125 relates to a consumer product and responsive to this determination may search a consumer product category of the second merchant's index to identify a consumer product. In some implementations, the data processing system 110 searches a subcategory of the electronics category of the index, such as a kitchen product accessories category, to identify a product (BLOCK 215) such as a toaster cover.

In some implementations, the data processing system 110 determines a quality metric such as a click through rate or conversion rate associated with the computing device 125. For example, the data processing system 110 can receive a computing device identifier (e.g., a number) representing the computing device 125 or other computing devices 129. Based on information associated with the computing device identifier, the data processing system 110 can determine at least one of a click through rate and conversion rate associated with the computing device identifier. The data processing system 110 (or a component thereof such as the content selection module 135) can identify a product from the indexed inventory based at least in part on the click through rate or other quality metric. For example, the data processing system 110 can identify a product (e.g., from information in the index) based on content items (e.g., ads) corresponding to the identified product that have a predicted or historical click through rate above a threshold level.

For situations in which the systems discussed here collect information about users, or may make use of information about users, the users may be provided with an opportunity to control whether programs or features that may collect user information (e.g., information about a user's social network, social actions or activities, a user's preferences, or a user's current location), or to control whether or how to receive content from the content server that may be more relevant to the user. In addition, certain data may be treated in one or more ways before it is stored or used, so that certain information about the user is removed when generating parameters (e.g., demographic parameters). For example, a user's identity may be treated so that no identifying information can be determined for the user, or a user's geographic location may be generalized where location information is obtained (such as to a city, ZIP code, or state level), so that a particular location of a user cannot be determined. Thus, users may have control over how information is collected about them and used by a content server.

In some implementations, historical data (e.g., click through or conversion rates) associated with a computing device identifier over a previous time period can be stored in the database 140 of the data processing system 110 separately or as part of one or more index. The data processing system 110 can determine a quality metric (e.g., click through or conversion rate) associated with the computing device 125 from the historical data. For example, the content selection module 135 may determine from data associated with the computing device identifier that the computing device 125 has actively clicked (e.g., has a high click through rate or a click through rate above a threshold value) on content for consumer products during the past several weeks (or other time period). Based at least in part on this information, the content selection module 135 can identify a consumer product from an inventory represented by one or more indices stored in the database 140 (BLOCK 215).

In some implementations, data associated with computing device purchase patterns or other historical information can be stored in the database 140. The historical data may indicate, for example, that a percentage of the computing devices 125 to 129 involved in a transaction to purchase a product from one of the merchant servers 120 to 124 were also involved the same or a different a transaction for another product. For example, historical data stored in the database 140 may indicate that computing device identifiers associated with transactions involving toasters have a click through rate above a threshold value for content related to blenders. From this information, the content selection module 135 can identify blenders from an index of inventory (BLOCK 215) responsive to a received indication of a transaction (BLOCK 205) that indicates a transaction involving purchase of a toaster.

In some implementations, the data processing system 110 can identify computer network activity of the computing device 125, and identify the product (BLOCK 215) based at least in part on the computer network activity. For example, historical data determined from a computing device identifier and indexed in the database 140 may indicate that the computing device 125 frequently accesses web pages of video games or has accessed content about video games in the past month or other time period. From this information, the content selection module 135 may identify content related to video game consoles to provide for display at the computing device 125 prior to completion of a transaction for another product that is taking place at the computing device 125.

In one implementation, the data processing system 110 provides an ad or other content corresponding to the product for display at a computing device prior to completion of the transaction (BLOCK 220). For example, the content placement module 130 may provide the content for display at the computing device 125 via the network 105. With reference to the above example involving a toaster and toaster cover, the data processing system 110 can provide (or instruct the second merchant server 121 to provide) an ad or other content such as an image of a toaster cover for display on a web page or other information resource at the computing device 125.

The content item (e.g., the toaster cover ad) can be provided to the computing device 125 for display (BLOCK 220) prior to completion of the transaction (e.g., prior to completion of the purchase of the toaster during a checkout process at the computing device 125). In this example, the toaster cover can be purchased together with the toaster in the same or a subsequent transaction at the computing device 125, with the toaster (or other good or service) provided by the first merchant and the toaster cover (or other good or service) provided by the second merchant.

The data processing system 110 can provide content corresponding to the one or more products for display at the computing device 125 (BLOCK 220) subsequent to receipt, by the data processing system 110, of the indication of a transaction at the computing device 125 to purchase a good or service (BLOCK 205). For example, the content placement module 130 may provide one or more advertisements or images of a toaster cover to be displayed at the computing device 125 (BLOCK 220) after receiving an indication that the computing device 125 is involved in a transaction to purchase a toaster (BLOCK 205). In this example, the content placement module 130 can select the content (e.g., an ad for a toaster cover) from the database 140 or from the second merchant server 121 for display at the computing device 125.

In some implementations, data included in the indication of the transaction received by the data processing system (BLOCK 205) includes a request for the data processing system 110 to identify at least one of multiple products from one or more indices stored in the database. For example, during the toaster purchase transaction at the computing device 125, the first merchant server 120 may send a request to the data processing system 110 for multiple content items identifying multiple additional goods or services associated with multiple different merchants to provide for display at the computing device 125.

In some implementations, subsequent to display of the advertisement or other content item (e.g., regarding the toaster cover identified from an index of inventory) at the computing device 125, the data processing system 110 can determine that the computing device 125 has clicked on that content item or been used to purchase a corresponding product (e.g., a conversion). This click through or conversion information can be stored in the database 140 and used by the data processing system 110 recursively to refine the content item selection process by influencing the selection of content to provide for display responsive to subsequent transactions at the same or a different computing device 125. For example, the data processing system 110 can determine that click through or conversion rates of content items for the toaster cover are above a threshold value, and responsive to this information the data processing system 110 can increase the frequency of selection of toaster cover related content items responsive to received indications of transactions for toasters or other products, goods or services.

In some implementations, the data processing system 110 can identify a group of merchants. For example, merchants of the group can agree to provide the data processing system 110 with provisions identifying the circumstances under which the data processing system 110 may recommend the merchant's products or services to a customer. For instance, those provisions may relate to prices, quality and quantities, locations of the consumers, or the relationship between merchants. Continuing with this example, the computing device 125 can be part of a transaction to purchase a product or service (e.g., a toaster) from the first merchant server 120. The content selection module 135 may select a product or service (e.g., a toaster cover) from a different merchant based on an interest determined from the transaction by the data processing system 110.

In some implementations, the different merchants can collaborate to allocate payments for the different items to their respective merchants. For example, one merchant may collect payment for both items, and then credit another merchant directly or via the data processing system 110. In this example, a merchant can aggregate payments from multiple transactions during a time period (e.g., monthly) and can reconcile credits or debits with other merchants periodically. In some examples, separate transactions can be made for items associated with different merchants, where the different merchants receive payment directly during each transaction without passing through an intervening merchant.

The transaction can be conducted using encrypted connections. For example, a third party (e.g., not the data processing system 110, or the merchant servers 120 to 124 or the computing devices 125 to 129) on the network 105 may be prevented from obtaining an indication of what products are bought by the customer or suggested by the data processing system 110. For example, the transaction can be conducted through protocols such as the Hypertext Transfer Protocol Secure (HTTPS) that can provide encrypted communication to prevent eavesdropping or unauthorized access and can securely identify the web server (e.g., the first merchant server 120) that communicates with the computing device 125.

In one implementation, the data processing system 110 may indicate to one of the merchant servers 120 to 124 that a credit is owed to the corresponding merchant. The data processing system 110 can communicate with merchant servers 120 to 124 to process payment plans (e.g., provide credits or bills) to or between merchants, e.g., on a periodic, per transaction or multiple transaction basis. The data processing system 110 can also provide content items associated with additional inventory at checkout for payment on a per-request basis, a per-additional revenue driven basis, a monthly basis, or for free.

In some implementations, the data processing system 110 provides an option to merchants via the respective merchant servers 120 to 124 to share purchase data with the data processing system 110 or with other merchant servers 120 to 124. For example, the first merchant server 120 could provide the data processing system 110 with click, or conversion (e.g., purchase) information that the data processing system 110 can evaluate to identify content items for products of the first merchant (corresponding to the first merchant server 120) or to identify content items of a different merchant. In this example the data processing system 110 can receive authorization from the first merchant server 120 to use this information to identify products of content items of other merchants.

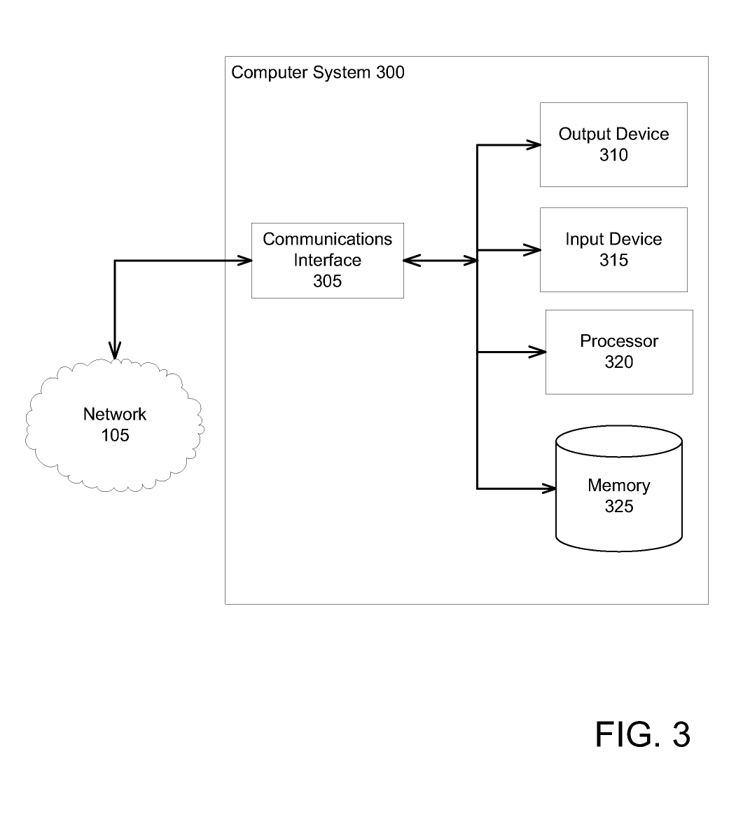

FIG. 3 shows the general architecture of an illustrative computer system 300 that may be employed to implement any of the computer systems discussed herein (including the system 100 and its components such as the data processing system 110, the content placement module 130, or the content selection module 135) in accordance with some implementations. The computer system 300 can be used to provide information via the network 105. The computer system 300 of FIG. 3 comprises one or more processors 320 communicatively coupled to memory 325, one or more communications interfaces 305, and one or more output devices 310 (e.g., one or more display units) and one or more input devices 315. The processors 320 can be included in data processing system 110 or the other components of the system 100 (such as the content placement module 130 and the content selection module 135).

In the computer system 300 of FIG. 3, the memory 325 may comprise any computer-readable storage media, and may store computer instructions such as processor-executable instructions for implementing the various functionalities described herein for respective systems, as well as any data relating thereto, generated thereby, or received via the communications interface(s) or input device(s) (if present). Referring again to the system 100 of FIG. 1, the database 140 can include the memory 325 to store indices associated with merchant inventory. The processor(s) 320 may be used to execute instructions stored in the memory 325 and, in so doing, also may read from or write to the memory various information processed and or generated pursuant to execution of the instructions.

The processor 320 may be communicatively coupled to or control the communications interface(s) 305 to transmit or receive various information pursuant to execution of instructions. For example, the communications interface(s) 305 may be coupled to a wired or wireless network, bus, or other communication means and may therefore allow the computer system 300 to transmit information to and/or receive information from other devices (e.g., other computer systems). While not shown explicitly in the system of FIG. 1, one or more communications interfaces facilitate information flow between the components of the system 100. In some implementations, the communications interface(s) may be configured (e.g., via various hardware components or software components) to provide a website as an access portal to at least some aspects of the computer system 300. Examples of communications interfaces 305 include user interfaces (e.g., web pages) having content (e.g., advertisements) selected by the content placement module 130 for placement on the web pages.

The output devices 310 may be provided, for example, to allow information to be viewed or otherwise perceived in connection with execution of the instructions. The input device(s) 315 may be provided, for example, to allow a user to make manual adjustments, make selections, enter data or various other information, or interact in any of a variety of manners with the processor during execution of the instructions. Additional information relating to a general computer system architecture that may be employed for various systems discussed herein is provided at the conclusion of this disclosure.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may be configured to provide an electronic programming guide to the user. A companion application to the smart television module may be operable on a mobile computing device to provide additional information about available programs to a user, to allow the user to control the smart television module, etc. In some implementations, the features may be implemented on a laptop computer or other personal computer, a smartphone, other mobile phone, handheld computer, a tablet PC, or other computing device.

The operations described in this specification can be implemented as operations performed by a data processing apparatus on data stored on one or more computer-readable storage devices or received from other sources.

The term “data processing apparatus,” “data processing system,” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The content placement module 130 and the content selection module 135 can include or share one or more data processing apparatuses, computing devices, or processors.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the internet), and peer-to-peer networks (e.g., ad hoc peer-to-peer networks).

The computing system such as system 300 or system 100 can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the content placement module 130 and the content selection module 135 can be a single module, a logic device having one or more processing circuits, or part of a search engine.

Having now described some illustrative implementations and embodiments, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations or embodiments.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementation,” “an alternate implementation,” “various implementation,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. For example, the computing devices 125 to 129 can include personal computers (e.g., desktops, laptops, tablets, smartphones, or personal digital assistants) used by a consumer at home or in a non-retail location. In one example, the computing device is or acts as a point of sale terminal. The computing device can be located at or a fixture of a retail location (e.g., a checkout register at a brick and mortar store) that can process transactions with a payment provider (e.g., a bank or credit card entity) via the network to purchase items from merchants. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A computer implemented method of providing information via a computer network, comprising:
receiving, by a data processing system via a computer network, an indication of a transaction with a first merchant;
creating, by the data processing system, an index representing an inventory of a second merchant, wherein the second merchant is independent of the first merchant;
identifying, using the index and data associated with the indication of the transaction, a product from the inventory of the second merchant; and
providing content corresponding to the product for display at a computing device prior to completion of the transaction.

2. The method of claim 1, wherein the computing device is an end user computing device, further comprising:
receiving the indication of the transaction at the data processing system via a server corresponding to the first merchant, the indication of the transaction originating with the computing device.

3. The method of claim 1, further comprising:
creating an index representing an inventory of the first merchant;
identifying a product from the inventory of the first merchant; and
providing content corresponding to the product from the inventory of the first merchant for display at the computing device.

4. The method of claim 1, further comprising:
determining at least one of a click through rate associated with the computing device and a conversion rate associated with the computing device; and
identifying the product based at least in part on at least one of the click through rate and the conversion rate.

5. The method of claim 1, wherein the product is a first product, further comprising:
receiving, by the data processing system, a request to identify at least one of a plurality products based on the data associated with the indication of the transaction, wherein the plurality of products includes the first product; and
providing the content corresponding to the product subsequent to receiving the request.

6. The method of claim 1, wherein the data associated with the indication of the transaction includes at least one of a click through rate and a conversion rate.

7. The method of claim 1, further comprising:
identifying computer network activity of the computing device; and
identifying the product based at least in part on the computer network activity.

8. The method of claim 1, further comprising:
obtaining, by the data processing system, at least one of click through data and conversion data corresponding to display of the content at the computing device.

9. A system of providing information via a computer network, comprising:
one or more data processors, and one or more storage devices storing instructions that when executed by the one or more data processors, cause the one or more data processors to perform operations comprising:
receiving an indication of a transaction with a first merchant;
creating an index representing an inventory of a second merchant, wherein the second merchant is independent of the first merchant;
identifying, using the index and data associated with the indication of the transaction, a product from the inventory of the second merchant; and
providing content corresponding to the product for display at a computing device prior to completion of the transaction.

10. The system of claim 9, wherein the one or more storage devices storing instructions that when executed by the one or more data processors, cause the one or more data processors to perform operations comprising:
receiving the indication of the transaction via a server corresponding to the first merchant, the indication of the transaction originating with the computing device.

11. The system of claim 9, wherein the one or more storage devices storing instructions that when executed by the one or more data processors, cause the one or more data processors to perform operations comprising:
creating an index representing an inventory of the first merchant;
identifying a product from the inventory of the first merchant; and
providing content corresponding to the product from the inventory of the first merchant for display at the computing device.

12. The system of claim 9, wherein the one or more storage devices storing instructions that when executed by the one or more data processors, cause the one or more data processors to perform operations comprising:
determining at least one of a click through rate associated with the computing device and a conversion rate associated with the computing device; and
identifying the product based at least in part on at least one of the click through rate and the conversion rate.

13. The system of claim 9, wherein the product is a first product, wherein the one or more storage devices storing instructions that when executed by the one or more data processors, cause the one or more data processors to perform operations comprising:
receiving a request to identify at least one of a plurality products based on the data associated with the indication of the transaction, wherein the plurality of products includes the first product; and
providing the content corresponding to the product subsequent to receiving the request.

14. The system of claim 9, wherein the data associated with the indication of the transaction includes at least one of a click through rate and a conversion rate.

15. The system of claim 9, wherein the product is a first product, wherein the one or more storage devices storing instructions that when executed by the one or more data processors, cause the one or more data processors to perform operations comprising:
identifying computer network activity of the computing device; and
identifying the product based at least in part on the computer network activity.

16. The system of claim 9, wherein the product is a first product, wherein the one or more storage devices storing instructions that when executed by the one or more data processors, cause the one or more data processors to perform operations comprising:
obtaining at least one of click through data and conversion data corresponding to display of the content at the computing device.

17. A computer readable storage device storing instructions that when executed by one or more data processors, cause the one or more data processors to perform operations comprising:
receiving an indication of a transaction with a first merchant;
creating an index representing an inventory of a second merchant, wherein the second merchant is independent of the first merchant;
identifying, using the index and data associated with the indication of the transaction, a product from the inventory of the second merchant; and
providing content corresponding to the product for display at a computing device prior to completion of the transaction.

18. The computer readable storage device of claim 17, further comprising:
instructions that when executed by one or more data processors, cause the one or more data processors to perform operations comprising:
creating an index representing an inventory of the first merchant;
identifying a product from the inventory of the first merchant; and
providing content corresponding to the product from the inventory of the first merchant for display at the computing device.

19. The computer readable storage device of claim 17, further comprising:
instructions that when executed by one or more data processors, cause the one or more data processors to perform operations comprising:
determining at least one of a click through rate associated with the computing device and a conversion rate associated with the computing device; and
identifying the product based at least in part on at least one of the click through rate and the conversion rate.

20. The computer readable storage device of claim 17, further comprising:
instructions that when executed by one or more data processors, cause the one or more data processors to perform operations comprising:
identifying computer network activity of the computing device; and
identifying the product based at least in part on the computer network activity.
